(19) United States
(12) Patent Application Publication
(10) Pub. No.: US 2001/0045188 A1
(43) Pub. Date: Nov. 29, 2001

(54) Cover for bowls such as pet food and water bowls

(76) Inventor: Steven Tsengas, Mentor, OH (US)

Correspondence Address: OLDHAM & OLDHAM CO, TWIN OAKS ESTATE, 1225 W MARKET STREET, AKRON, OH, 44313, US

(21) Appl. No.: 09/813,746

(22) Filed: Mar. 21, 2001

Related U.S. Application Data
(60) Provisional application No. 60/193,963, filed on Mar. 31, 2000.

(51) Int. Cl. A01K 1/10; A01K 5/00; A01K 39/00

(52) U.S. Cl. 119/51.01

(57) ABSTRACT

A cover for a bowl such as a pet food or water bowl that consists of a dip molded cover on the outer surface of a bowl to provide features such as a visually appealing appearance, protection, and insulation. The cover of the present invention may be fabricated of rubber or plastic material and may be permanently or removeably secured to the outer surface of the bowl.

### BACKGROUND AND SUMMARY OF THE INVENTION

The present invention relates generally to new and novel improvements in a cover for a bowl. More particularly, the present invention relates to a cover for one or more bowls such as pet food and/or water bowls. The cover is preferably durable and lightweight and provides a visually appealing appearance, as well as protection, for a bowl.

Pet food and water bowls are often fabricated from a stainless steel material to provide durability, as well as sanitary benefits. Such stainless steel bowls normally have an outer surface that is smooth, shiny and silver. These bowls are also often fabricated of other materials such as glass or plastic. These bowls have limitations as well. Glass bowls are breakable while some plastic bowls may stain which creates an unattractive outer surface. While a shiny or transparent outer surface is appealing to some, others may prefer a different type of outer surface. Achieving an outer surface which is less shiny, not completely transparent and/or a different color is difficult to accomplish by modifying the composition and/or the finish of stainless steel material and variations which can be accomplished thereby are somewhat limited. In addition, colored glass can be expensive while colored plastic bowls may also have the problem of staining.

Further, bowls, especially those used for pet food or water, are often lightweight. This characteristic makes it easy for the pet owner to carry and move the bowl when it is full of food or water. Although being lightweight makes handling the bowl simpler for the pet owners, it may make eating or drinking difficult for pets or causes annoyances to the pet owner. For instance, a bowl with a smooth stainless steel or glass bottom may tend to slide along a smooth surface. The action of a pet, such as a dog, eating from the bowl tends to push the bowl and cause it to move. The movement of the bowl along the floor may scratch the surface of the floor or may just be noisy. In addition, the pushing of the bowl may cause the bowl to move to a portion of the floor where the pet owner did not want the pet or the bowl to go.

Accordingly, an object of the present invention is the provision of a cover for a bowl such as a pet food or water bowl that is capable of changing the outer appearance of the bowl.

Another object of the present invention is to provide a cover for a bowl that minimizes and substantially precludes the bowl from slipping and sliding along a surface such as a floor or other surface upon which it is placed.

Yet another object of the present invention is to provide a cover for a bowl that provides some level of insulation for the contents of the bowl. For example, the present invention may slow the transfer of ambient heat to cold water in the bowl. As another example, the cover of the present invention, may be placed on a serving bowl and may slow the cooling of the hot foods in the serving bowl or prevent the hot surface of the bowl from causing heat damage to the table surface.

These and other objects of the present invention are attained by a cover for bowls that consists of a cover placed on the outer surface of a bowl such as by dip molding. The cover may also be manufactured by various other known means for shaping plastic or rubber type materials. The cover is preferably formed of a pliable material. The cover may provide a visually appealing appearance, as well as protection, for one or more bowls. The cover preferably has a slight to zero interference fit with the outer surface of the bowl to normally remain on the outer surface of the bowl when it is lifted and/or moved. In a preferred embodiment, the cover is substantially formed to the shape of the bowl to fit over the outer surface of the bowl. At the same time, the cover is preferably removable from the bowl. The cover is may be fabricated of various materials such as rubber or plastic based material to provide resistance to substantially prevent the bowl from slipping or sliding along the floor or other surface upon which it is placed. In addition, the cover can provide insulation for the contents of the bowl on which the cover is placed.

Other advantages and novel features of the present invention will become apparent in the following detailed description of the invention when considered in conjunction with the accompanying drawing.

### BRIEF DESCRIPTION OF THE DRAWINGS

FIG. 1 is an elevational view, in partial cross-section of a cover positioned on the outer surface of a bowl in accordance with one embodiment of the present invention.

FIG. 2 is a top view of the cover shown in FIG. 1.

FIG. 3 is an elevational view of the cover of the present invention, the bowl being illustrated by ghost lines to show environment.

FIG. 4 is a bottom view of the cover shown in FIG. 1.

FIG. 5 illustrates the cover of the invention as it may be configured to hold more than one bowl in a line series.

FIG. 6 illustrates the cover of the invention as it may be configured to hold three bowls in a triangular orientation.

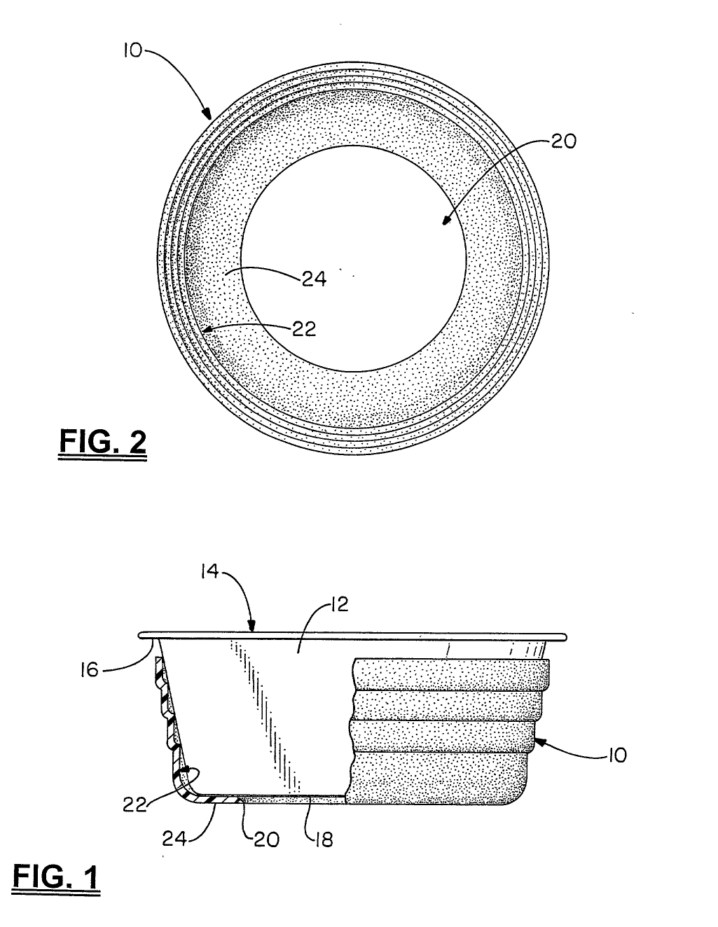

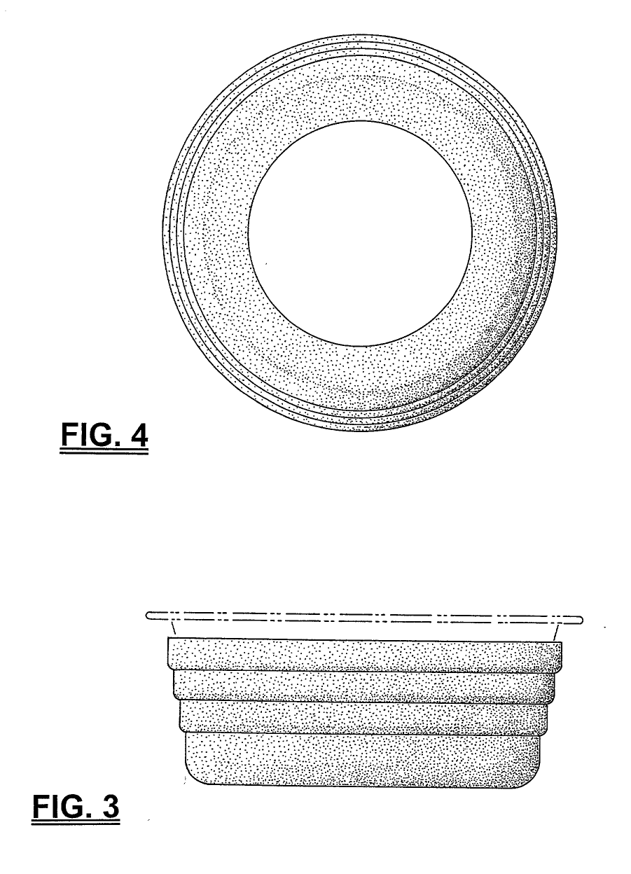

### DETAILED DESCRIPTION OF THE INVENTION

In the following detailed description of a preferred embodiment of the present invention, reference is made to the accompanying drawings which, in conjunction with this detailed description, illustrates and describes a preferred embodiment of a cover for a bowl in accordance with the present invention.

Referring now to FIG. 1 the bowl portion of the present invention is generally designated 14 and the cover is generally designated 10. The figure shows a side cross-sectional view of a cover for a bowl positioned on the outer surface of the bowl in accordance with a preferred embodiment of the present invention. Cover 10 is preferably substantially formed to the outer surface 12 of a bowl 14 such as by dip molding, although other methods of formation are contemplated. The cover has an opening in the top which is adapted to receive the bowl. When the bowl is positioned inside the cover, the bottom of the bowl abuts against the bottom of the cover. Cover 10 preferably has a slight interference fit with outer surface 12 of the bowl 14 to normally remain on outer surface 12 of the bowl 14 when it is lifted and/or moved. Cover 10 may have grooves or projections on the inner and/or outer surface to facilitate holding said cover onto said bowl by frictional forces between said inner surface of the cover and the outer surface of the bowl. The grooves may be formed into the cover itself or attached to the cover. It is contemplated that cover could extend various distances on the side surfaces of the bowl and is not required to cover the entire outer surface of the bowl. At the same time, cover 10 is preferably removable from outer surface 12 of the bowl 14. Although a preferred embodiment of the present invention uses a slight interference fit between cover 10 and outer surface of bowl 12 to hold cover 10 onto the bowl 14, other means for securing cover to bowl could also be used. For instance, a portion of the inner surface 22 of cover 10 could be coated with an adhesive to secure cover to bowl. The adhesive could be a permanent adhesive, but may also be a temporary adhesive such as a pressure sensitive adhesive. It is contemplated that an adhesive could coat the entire inner surface 22 of cover or be placed only around the margins of the inner surface 22 of the cover 10 to secure cover to bowl 14. Further, cover 10 could be fabricated of a material which has naturally “sticky” properties. The inner surface of cover could be left “sticky” to adhere to the bowl while the outer surface is treated to reduce or substantially eliminate stickiness to make handling of the bowl more convenient. In addition, if desired, cover 10 could be extended to cover a flange 16 on a bowl 14 to substantially preclude removal of cover 10 from the bowl 14 or to make removal of cover 10 from bowl 14 more difficult. Cover may additionally be secured by clips or other mechanical means.

It should be noted that although the drawings in the present application show cover extending almost the entire length of the outer surface, this is not a requirement for the present invention. In the embodiment of the present invention where frictional forces hold the cover to the outside surface of bowl, it is the circumferential contact between the outer surface of the bowl and the inner surface of the cover which helps to hold the cover onto the bowl. Thus, in this embodiment, the cover only needs to extend as far along the outer length of the bowl as is necessary to hold cover on the bowl by the frictional forces between the cover and the outer surface of the bowl. Further, in embodiments where other means are used to secure cover to the outer surface of bowl such as adhesives, cover can cover an even wider variety of lengths along the outer surface of the bowl.

In a preferred embodiment the material chosen for cover 10 is preferably a pliable material such as rubber, plastic or a polymer based material. In a preferred embodiment the material is capable of providing resistance to the bowl 14 to substantially reduce slipping and/or sliding along the floor or other surface upon which the bowl 14 is placed. In addition, cover 10 can provide insulation for the contents of the bowl 14 on which cover is placed. One material which could be used to fabricate cover 10 is plastisol. Furthermore, it is contemplated that cover 10 could be fabricated in a variety of colors.

The cross-sectional thickness of cover 10 can be chosen considering such factors as the material used to fabricate cover 10, the dip molding or other plastic or rubber forming process used to fabricate cover, the desired appearance of cover, desired resistance to slipping and sliding, and the desired insulative properties of cover 10. Cover 10 preferably has the same profile as the bowl with which it is used and has a minor to zero (0) clearance with outer surface 12 of the bowl 14. If desired, cover 10 can extend across the entire bottom surface 18 of the bowl 14. However, in a preferred embodiment, cover 10 includes opening 20 in the bottom surface 24 to facilitate drainage from the interior of cover for pet food and water bowls 10.

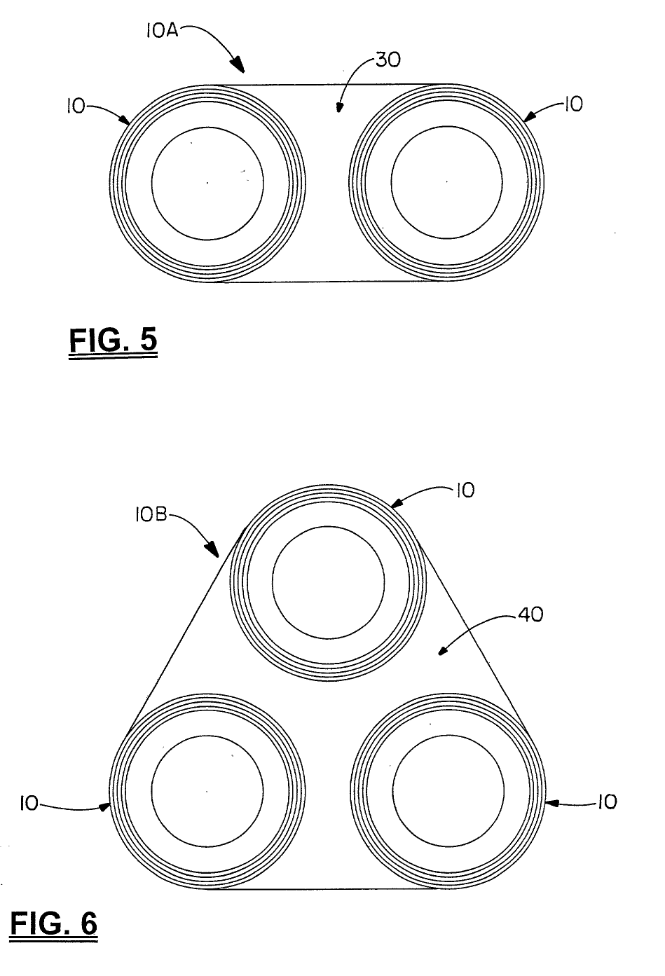

Although cover for pet food and water bowls 10 is shown being used in conjunction with a single bowl 14, two (2) or more bowls 14 could be covered with a single cover if desired. For example, and as illustrated in FIG. 5, two (2) bowls could have a single cover 10A consisting of two (2) bowl portions 10 connected by a web 30, preferably in the range of one (1) inch to three (3) inches wide, extending between the two (2) bowl portions. In addition, and as illustrated in FIG. 6 three (3) bowls positioned in a triangular configuration could have a single cover 10B consisting of three (3) bowl portions 10 connected by a central web 40 extending between the three (3) bowl portions. In a similar manner, four (4) or more bowls could be connected by a single cover in a “straight line,” in a “star” configuration or in other configurations.

Although it is a preferred embodiment of the present invention to use the cover described herein with pet food and water bowls, other uses are clearly contemplated and should not be considered outside the scope of the invention. For instance, the present invention may be used with glass, plastic or stainless steel serving bowls. Often when someone places hot foods in a serving bowl, the outer surface of the bowl becomes heated. In order to avoid burning his or her hands when carrying the bowl, the user may use potholders or a towel placed around the bowl to carry it. This may sometimes cause messes or breaking of the bowl, if the bowl slips out of the protective towel or potholder covering and is dropped by the user. In the case of any bowls, this may cause spillage of food. Especially in the case of a glass bowl, the bowl may break when it is dropped. The cover may facilitate carrying such serving bowls which have hot foods therein without causing discomfort to the user's hands. In addition, the cover may alleviate the problem of the bowls slipping out of the users hands, because the cover is secured to the bowl. Further, the cover may provide insulation to substantially avoid causing heat damage to the surface of the table. The cover as described herein may also be used to prevent the bowls from sliding along the surface of a table, thereby causing scratching of the surface of the table. The cover may additionally provide a cushion in the case of a bowl being dropped. This cushion could protect a glass bowl from breaking when dropped or prevent a large amount of noise when a stainless steel or glass bowl is dropped on to a hard surface. Another advantage is that the cover would provide insulation to hot or cold foods in the bowls.

It is contemplated that the bowls and covers of the present invention could be packaged in a variety of manners. A bowl and cover could be sold as a unit, with one bowl and one cover placed thereon. In addition, the multiple bowl covers could be sold as a single package containing the covers and bowels. However, it is also contemplated that sets of covers could be sold separately from bowls. For instance, the sets of covers may contain several covers each having a different color. In this example, the pet owner could frequently change the appearance of his pet's bowl. In another example, the covers may come in various sizes to fit various bowls. These covers could be used for multiple pet bowls. In the alternative, such cover sets could be used for a set of serving bowls to create a stylish or matching appearance for the bowls. These are only a few examples of how the covers of the present invention may be packaged and sold.

Although the present invention has been described above in detail, the same is by way of illustration and example only and is not to be taken as a limitation on the present invention. For example, further features and advantages of the cover for bowls in accordance with a preferred embodiment of the present invention are shown and described in the drawings. In addition, the cover for bowls in accordance with the present invention could be modified in various ways. Accordingly, the scope and content of the present invention are to be defined only by the terms of the appended claims.

What is claimed is:

1. A cover for an outer surface of a bowl comprising:
a pliable material substantially formed to the shape of an outer surface of said bowl, wherein said cover has a top opening adapted to receive a bowl and a bottom portion adapted to engage a bottom surface of said bowl.

2. The cover as recited in claim 1 wherein said cover comprises a material selected from the group consisting of rubber and synthetic polymers.

3. The cover as recited in claim 1 wherein said cover comprises plastisol.

4. The cover as recited in claim 1 wherein said cover is removeably secured to said outer surface of said bowl.

5. The cover as recited in claim 4 wherein said cover is removeably secured to said outer surface of said bowl by having a slight interference fit with said outer surface of said bowl.

6. The cover as recited in claim 4 wherein said cover is removeably secured to said outer surface of said bowl by means of a releasable adhesive.

7. The cover as recited in claim 1 wherein said cover is secured to said outer surface of said bowl by means of an adhesive.

8. The cover as recited in claim 1 wherein said cover is secured to said outer surface of said bowl by having minor to zero clearance between an inner surface of said cover and an outer surface of said bowl.

9. The cover as recited in claim 1 wherein said cover has an opening in said bottom portion of said cover.

10. The cover as recited in claim 1 wherein said cover is fabricated of a material having sticky properties and said cover is secured to said bowl by means of said sticky properties.

11. The cover as recited in claim 1 wherein said cover is formed by dip molding.

12. The cover as recited in claim 1 wherein said cover further comprises a plurality of bowl receiving portions connected by a web.

13. A bowl assembly comprising:
a bowl; and
a cover comprised of a pliable material substantially formed to the shape of an outer surface of said bowl, wherein said cover has a top opening adapted to receive a bowl and a bottom portion adapted to engage a bottom surface of said bowl.

14. The bowl assembly as recited in claim 13 wherein said cover comprises a material selected from the group consisting of rubber and synthetic polymers.

15. The bowl assembly as recited in claim 13 wherein said cover comprises plastisol.

16. The bowl assembly as recited in claim 13 wherein said cover is removeably secured to said outer surface of said bowl by having a slight interference fit with said outer surface of said bowl.

17. The bowl assembly as recited in claim 12 wherein said cover is removeably secured to said outer surface of said bowl by means of a releasable adhesive.

18. The bowl assembly as recited in claim 12 wherein said bowl comprises a flange extending outwardly from a top opening of said bowl and wherein said cover extends to cover said flange.

19. The bowl assembly as recited in claim 13 wherein said cover further comprises a plurality of bowl receiving portions connected by a web.

20. A cover for an outer surface of a bowl comprising:
a pliable polymeric material substantially formed to the shape of an outer surface of said bowl;
a top opening adapted to receive a bowl;
a bottom portion adapted to engage a bottom surface of said bowl, wherein said bottom portion has an opening therein,
wherein said cover is secured to a bowl through frictional forces between the outer circumference of said bowl and the inner surface of said cover; and
wherein said inner surface of said cover has projections formed therein to facilitate securing said cover to said bowl.
